(19) United States
(12) Patent Application Publication
(10) Pub. No.: US 2024/0388470 A1
(43) Pub. Date: Nov. 21, 2024

(54) EDGE COMPUTING

(71) Applicant: MICROSOFT TECHNOLOGY LICENSING, LLC, Redmond, WA (US)

(72) Inventor: Thomas David PRICE, San Francisco, CA (US)

(21) Appl. No.: 18/199,889

(22) Filed: May 19, 2023

(51) Int. Cl. H04L 12/46

(52) U.S. Cl. CPC H04L 12/467

(57) ABSTRACT

An on-premises compute and networking server comprises a network gateway virtual machine having layer three switching functionality. The compute and networking server has a plurality of physical ports physically connected to a layer two communications network at the premises. The layer two communications network only comprises layer two equipment and a modem or other internet access equipment.

### BACKGROUND

Edge computing uses computing equipment locally at the “edge” of a communications network for the bulk of computing tasks rather than using compute resources in the core of a communications network (such as data centre compute nodes, web servers and other central compute resources). Edge computing often uses computing equipment on-premises at a site such as a factory, oil-rig, warehouse site or other site. Edge computing seeks to make real-time computing possible in locations where it would not normally be practical. Edge computing may reduce bottlenecks in communications networks.

Edge computing may be used to provide telecommunications services such as management of private mobile networks including fifth generation 5G private networks or other types of services including but not limited to: processing of video feeds with artificial intelligence, real time control of robotics equipment, processing large volumes of data from sensors, controlling manufacturing or agricultural equipment.

The embodiments described below are not limited to implementations which solve any or all of the disadvantages of known edge computing deployments.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

Often, edge computing equipment at a site such as a factory, oil-rig, warehouse or other site, is connected to a communications network at the site via a layer three switch which is a relatively expensive piece of hardware. Various examples provide deployments where a layer three switch is absent.

An on-premises edge compute and networking server comprises a network gateway virtual machine having layer three switching functionality. The compute and networking server has a plurality of physical ports physically connected to a layer two communications network at the premises. The layer two communications network only comprises layer two equipment and a modem or other internet access equipment. The layer two communications network comprises a layer two switch physically connected to the physical ports: or the layer two communications network is deployed absent a layer three switch and the network gateway virtual machine has layer three switching functionality.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a plurality of sites having edge computing equipment;

FIG. 2 is a schematic diagram of an edge compute element comprising a layer three switch;

FIG. 3 is a schematic diagram of another edge compute element:

FIG. 4 is a schematic diagram of an edge compute element with a layer two switch;

FIG. 5 is a schematic diagram of an edge compute element with no layer two switch and no layer three switch:

FIG. 6 is a schematic diagram of an edge compute element with specialist hardware:

FIG. 7 is a flow diagram of a method during manufacture:

FIG. 8 is a flow diagram of a method of remote management of a compute and networking server:

FIG. 9 illustrates an exemplary computing-based device in which embodiments of a compute and networking server are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As mentioned above edge computing often uses computing equipment on-premises at a site such as a factory, oil-rig, warehouse site or other site. An edge compute element comprising an on-premises server, typically has a physical layer three switch. A layer three switch is hardware that operates at both layer two and layer three, allowing devices connected to different virtual local area networks (VLANs) of a layer two on-premises communications network to communicate with one another without going through a dedicated router. VLANs enable dividing one network of physically connected devices into a plurality of logical networks that are unable to directly communicate with one another. Using a VLAN components of one physical device may be carved off into different networks. The inventor has recognized that physical layer three switches are relatively expensive and has conceived various ways to deploy an edge compute element 100 without a layer three switch whilst retaining the same functionality as if a layer three switch were used.

In various examples the edge compute element has a network gateway virtual machine to replace some or all of the functionality of the layer three switch. In various embodiments the edge compute element enables border control of a layer two communications network with VLANs without a layer 3 switch.

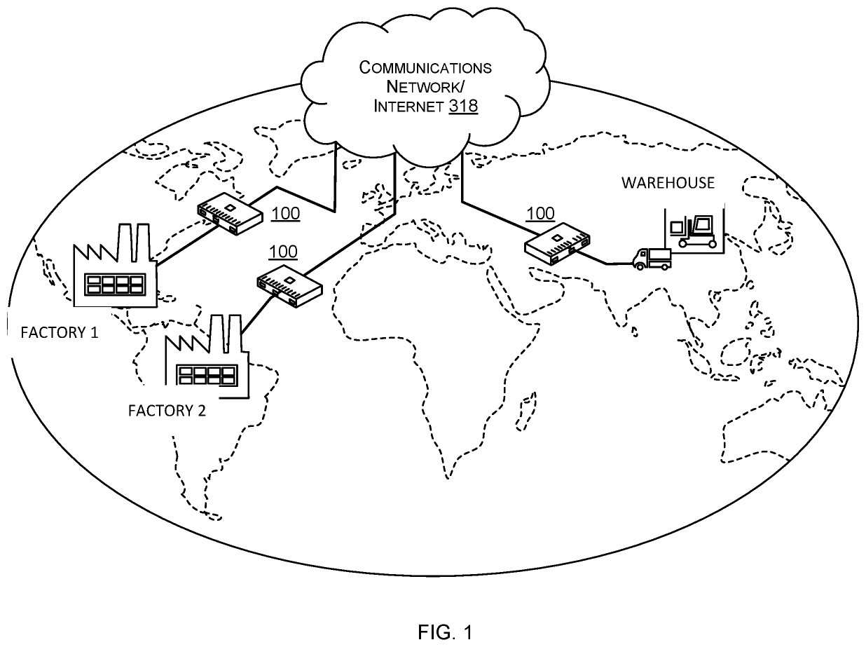

FIG. 1 is a schematic diagram of a plurality of sites having edge computing equipment. The sites include factory 1, factory 2 and a warehouse site. The sites are at different geographical locations. In practice there may be many more sites. Each site has a layer two communications network comprising communications network nodes at the site such as radio access equipment, modems, compute servers, or other physical communications network equipment. A layer two communications network is a communications network that uses a layer two protocol of the Open Systems Interconnection, OSI, networking model. An example of a layer two network protocol is Ethernet protocol. Devices in an Ethernet network are identified by a media access control, MAC, address which is generally hardcoded to a particular device and doesn't normally change. A layer three communications network is a communications network that uses a layer three protocol of the OSI networking model such as Internet Protocol IP. Devices in an IP network are identified by an IP address which can be dynamically assigned and may change over time.

Each site has an edge compute element 100 which is a physical on-premises server. In some approaches, each edge compute element 100 comprises a physical layer three switch. A layer three switch is hardware that operates at both layer two and layer three, allowing devices connected to different virtual local area networks (VLANs) of the layer two on-premises communications network to communicate with one another without going through a dedicated router. VLANs enable dividing one network of physically connected devices into a plurality of logical networks that are unable to directly communicate with one another. Using a VLAN components of one physical device may be carved off into different networks. The inventor has recognized that physical layer three switches are relatively expensive and has conceived various ways to deploy an edge compute element 100 without a layer three switch whilst retaining the same functionality as if a layer three switch were used.

Each edge compute element 100 has an on-premises compute and networking server. Since the compute and networking server is on-premises it is secure by restricting access to it on site and, where the site is geographically remote from other communications networks such as in the case of an oil-rig, having an on-premises server enables communications network functionality to be provided at the remote site. The server has a network gateway virtual machine with layer three switching functionality. Using a network gateway virtual machine enables generic hardware to be used to deploy the server since the network gateway is virtual and does not have to be implemented using specialist hardware. The network gateway virtual machine has layer three switching functionality which enables communications between different VLANs at the premises to be achieved without a dedicated router. The layer two communications network only comprises layer two equipment and a modem or other internet access equipment. Physical connections such as optic fibre, ethernet cables or other physical connections enable reliable, secure communication on-premises. Because the layer two communications network only comprises layer two equipment and a modem or other internet access equipment there is no layer three switch and so costs are reduced. Scalability is also improved as compared with using one layer three switch per site. Security is also improved since a single entity controls the server as compared with having one entity controlling a layer three switch and a separate entity controlling a compute and networking server.

Each edge compute element may execute an application to provide a service. A non-exhaustive list of example services is: a 5G private network, a voice mail service, processing of video feeds with artificial intelligence, real time control of robotics equipment, processing large volumes of data from sensors, controlling manufacturing or agricultural equipment, a telecommunications service. The application is deployed using one or more virtual machines or containers. In the example of FIG. 1 each edge compute element 100 is in communication with the internet 318 and is able to be managed remotely by a management service accessing the edge compute element via the internet 318 as described in more detail below. However, it is not essential to have remote management of the edge compute elements 100.

In an example, factory 1 has a layer two communications network comprising a radio access node enabling mobile phones at the factory to communicate with one another over a 5G private network provided by the edge compute element 100. In some cases the 5G private network spans more than one site, such as factory 1 and factory 2 in FIG. 1.

A network gateway virtual machine of the disclosure operates in an unconventional manner to enable border control of a layer two communications network with VLANs without a layer 3 switch.

A network gateway virtual machine improves the functioning of the underlying edge computing element by facilitating border control for a layer two communications network with VLANs and bypassing a layer 3 switch.

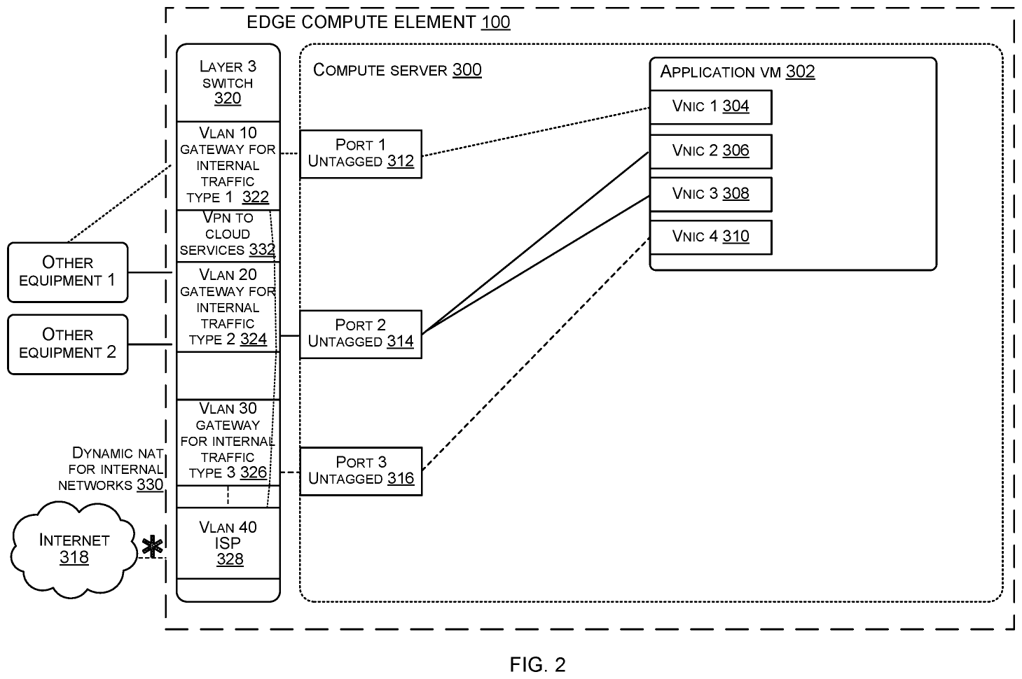

FIG. 2 is a schematic diagram of an edge compute element 100 comprising a layer three switch 320. The inventor has recognized that the approach of FIG. 2 is costly as now explained. The edge compute element 100 is on premises at a site and comprises a compute server 300 and a layer three switch 320 both of which are physical apparatus. The layer three switch is connected to the compute server by optic fibre, wired connections or other physical connections from the layer 3 switch to ports of the compute server 300. Three ports are shown, port 1 312, port 2 314 and port 3 316. It is possible for there to be one or more layer 2 switches between the compute server 300 and the layer 3 switch 320.

At the site is a layer two communications network comprising other equipment 1, other equipment 2 and an apparatus for connection to the internet such as a modem located at the asterix in FIG. 2 which is connected to the layer 3 switch 320. Other equipment 1 and other equipment 2 are any layer two communications network hardware such as a compute server, a radio access node, a database node, a management workstation, or any other on-premises equipment. The other equipment is physically connected to the layer 3 switch 320 using optic fibre or wired connections. It is possible for there to be one or more layer 2 switches between the other equipment and the layer 3 switch 320.

The compute server 300 comprises an application virtual machine 302 executing one or more applications such as to provide a 5G private network to mobile phones at the site. The application virtual machine comprises a plurality of virtual network interfaces vNICs 304 to 310.

In the example of FIG. 2 the layer two communications network has four VLANs: VLAN 10, VLAN 20, VLAN 30 and VLAN 40. The layer 3 switch has three VLAN gateways: VLAN 10 gateway 322 for internal traffic type 1 which is internal to the layer two communications network, VLAN 20 gateway 324 for internal traffic type 2, and VLAN 30 gateway 326 for internal traffic type 3. VLAN 40 connects to an internet service provider 328 such as via a modem in the layer 2 network thus enabling connection to the internet 318. The layer 3 switch carries out dynamic network address translation NAT 330. Thus an IP address of the edge compute element 100 visible to entities via the internet 318 is translated into an appropriate address in the local layer 3 network: then in turn the local layer 3 address is mapped to a layer two address.

Communications packets from nodes in the layer two communications network that are part of VLAN 20 reach the VLAN 20 gateway 324 and are switched to port two 314 and forwarded to vNICs 306 and 308 for processing by the application VM. The processing is done by the application VM such as to implement a service such as 5G data processing, voice mail or another service. Sometimes the application consumes the traffic. Sometimes the traffic is converted into different traffic on a different port (e.g. 5G data traffic coming in on vNIC 3 might have some headers removed and then be transmitted out on vNIC 4 towards the Internet).

Communications packets from nodes in the layer two communications network that are part of VLAN 10 reach VLAN 10 gateway 322 and are switched to port one 312 and forwarded to vNIC 304 for processing. They terminate at vNIC 304.

Communications packets from nodes in the layer two communications network that are part of VLAN 10 reach VLAN 10 gateway 322 and, in response to an indication that an internet service is being requested, are sent on a virtual private network 332 to VLAN 40 which forwards the request to internet 318 via a modem or other internet access equipment which is part of the layer two network at the site.

In the arrangement of FIG. 2 a physical layer 3 switch 320 is used which is costly and complex. The layer 3 switch 320 is external networking hardware to provide connectivity to a wider network beyond the layer two network. The layer 3 switch performs border gateway functions such as Network Address Translation (NAT) to a public IP address, and blocking unwanted inbound traffic from the Internet 318. This facilitates the edge compute element 100 to be managed from the cloud, and it provides Internet connectivity to the application(s) executing at the application VM 302. Enabling management from the cloud is useful to facilitate debugging, obtaining diagnostics of VLANs, reconfiguring ports or for other purposes.

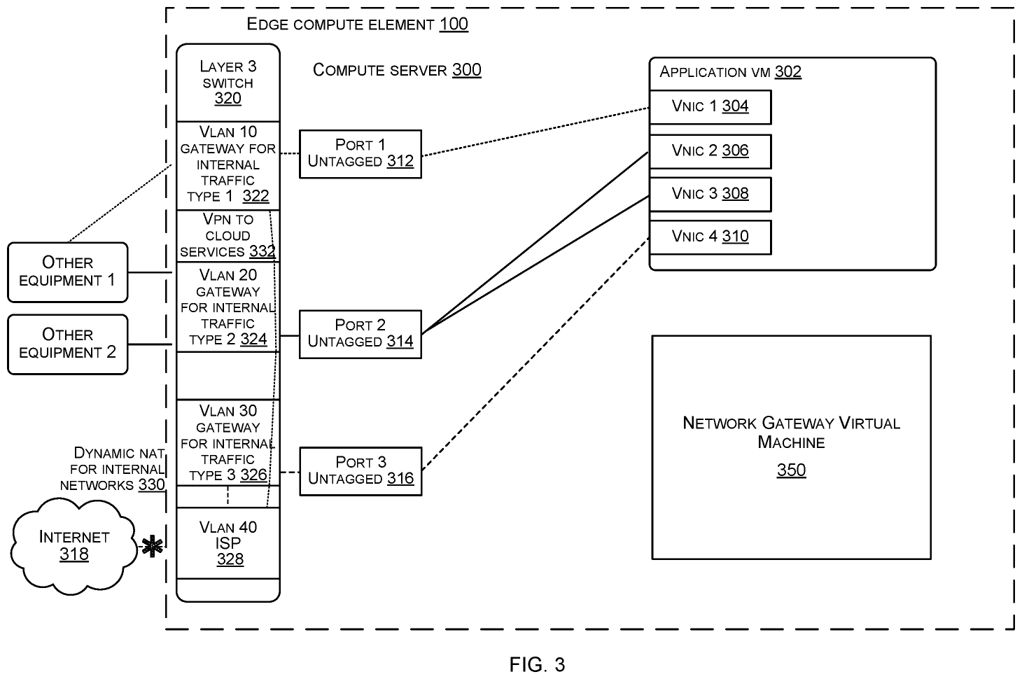

FIG. 3 is a schematic diagram of another example of an edge compute element 100 which has a layer three switch 320. In this example the compute server 300 comprises a network gateway virtual machine 350. The network gateway virtual machine 350 provides border gateway functions to applications running on the compute server. However, the layer three switch 320 is used otherwise there is a chicken-and-egg situation where the network gateway VM 350 doesn't exist until after the edge compute element 100 has been deployed, so it can't be used to manage the deployment process. Also, during upgrade the network gateway VM 350 is down for some time, and if the compute server 300 desires external network connectivity during the upgrade process, that might be interrupted at a crucial moment. It's possible to add redundant hardware to avoid this problem, but that increases cost.

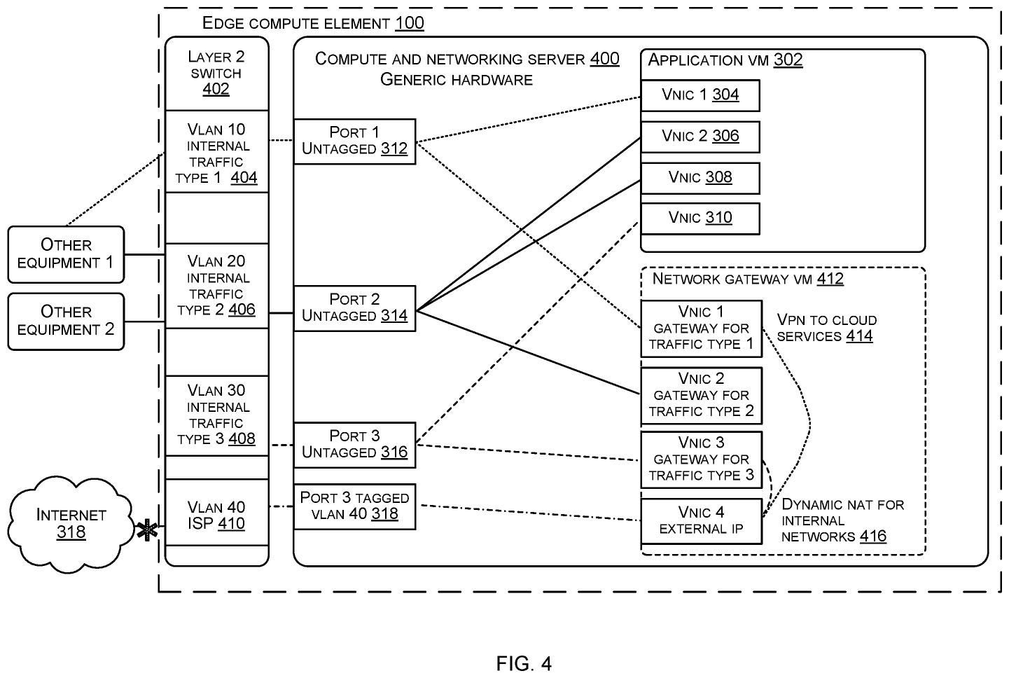

FIG. 4 is a schematic diagram of an edge compute element 100 with a layer two switch 402. By using a layer two switch 402 costs are reduced as compared with using a layer three switch. The layer two switch 402 comprises functionality to forward packets for each of a plurality of VLANs of the layer two communications network. In this example there are four VLANs although other numbers of VLANs may be used in practice. VLAN 10, 404 is for internal traffic type 1. VLAN 20, 406 is for internal traffic type 2. VLAN 30, 408 is for internal traffic type 3 and VLAN 40 is for traffic to or from the Internet 318 via a modem or other internet access equipment which is part of the layer two network at the site.

The edge compute element 100 has a compute and networking server 400 deployed using generic hardware such as an Intel (trade mark) server with standard processors and standard network cards or other standard hardware. The generic hardware is absent specialist network hardware.

The compute and networking server 400 comprises a network gateway virtual machine 412 which has a plurality of virtual network interfaces vNICs. In this example there is one vNIC per VLAN. vNIC 1 is a gateway for traffic type 1, vNIC 2 is a gateway for traffic type 2, vNIC 3 is a gateway for traffic type 3 and vNIC 4 is for traffic to or from the Internet 318. Thus, the network gateway virtual machine 412, and the ports, in this example take the gateway functionality of the layer 3 switch of the embodiments of FIGS. 2 and 3 so enabling a layer 2 switch 402 to be used and saving costs and complexity. Security is enhanced since one entity controlling the compute and network server 400 controls the gateway functionality. In addition to basic border gateway functionality, the network gateway VM 412 can provide networking and firewall capabilities such as VPN connections to the cloud and deep packet inspection.

In the example of FIG. 4, internal traffic type 1 comprising packets reaching VLAN 10 in the layer 2 switch 402 from other equipment 1 is switched to port 1, 312. Internal traffic type 1 is forwarded from port 1, 312 to either application VM, vNIC 304 if it is to remain in the layer 2 communications network, or to vNIC 1 if it is destined for the Internet 318. Once reaching vNIC 1 the packets destined for the internet are forwarded on a virtual private network 414 to vNIC 4 which does network address translation and forwards them to port 3 after tagging them to indicate port 3 tagged VLAN 30, 318. Port 3 tagged forwards the packets to layer 2 switch 402 VLAN 40 which sends them to a modem or other communications network element with access to the internet 318. Note that port 3 has been modified as compared with FIG. 2 since the single physical connection from the layer 2 switch 402 to the compute and network server 400 for port 3 is logically used as two connections by tagging packets. Those which are untagged are shown schematically (to aid understanding of the technology) as going to port 3 untagged 316 and those which are tagged are shown schematically as going to part 3 tagged although in practice port 3 is a single port. Thus there are two VLANs running over the single cable between the layer 2 switch 402 and port 3.

In the example of FIG. 4, internal traffic type 2 comprising packets reaching VLAN 20 in the layer 2 switch 402 from other equipment 1 or other equipment 2 is switched to port 2 untagged 314 of the compute and networking server 400. Port 2 forwards the packets to vNIC 2 306 of the application VM 302 or vNIC 3, 308 of the application VM 302 according to addresses in headers of the packets.

In the example of FIG. 4, internal traffic type 3 comprising packets reaching VLAN 30, 408 from vNIC 3, 310 are switched to port 3 untagged 316 and forwarded from port 3 to vNIC 3 gateway of the network gateway VM 412. If they are destined for the internet they are sent to vNIC 4 external IP where network address translation is done before forwarding to port 3 tagged VLAN 40, 318.

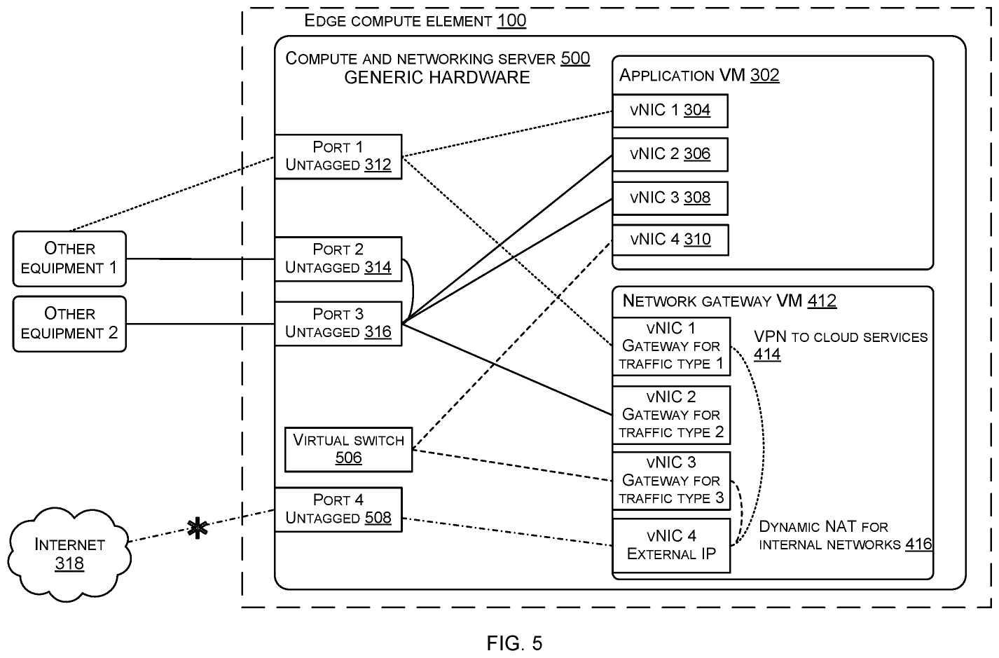

FIG. 5 is a schematic diagram of an edge compute element 100 with no layer two switch and no layer three switch. In this example the edge compute element comprises only a compute and networking server 500 since there is no external layer 2 switch and no external layer 3 switch. The number of ports of the compute and networking server 500 is increased by one as compared with the example of FIG. 4 and where the same number of VLANs are deployed and a virtual switch 506 is added in the compute and networking server 500 between vNIC 3 gateway for traffic type 3 and vNIC 4 310 of the application VM 302. In this example, the functionality of the layer 2 switch from FIG. 4 is moved into the ports of the compute and networking server 500. In order to do this an additional port is added in the compute and networking server 500 as now explained. The additional port is used for traffic type 2 and is connected physically to other equipment 2 in the layer 2 communications network. Packets of traffic type 2 reaching port 2 are forwarded to vNIC 2 gateway in the network gateway VM if they are destined for the internet. Packets of traffic type 2 reaching port 2 are forwarded to vNIC 2 or vNIC 3 in the application VM 302 if they are destined for the layer 2 communications network.

Traffic from the internet reaches vNIC 4 in the network gateway VM 412 which does network address translation and forwards the packet to vNIC 3 if the traffic is type 3. From vNIC 3 the type 3 traffic goes to virtual switch 506 and from there to vNIC 4, 310 in the application virtual machine 302 for processing before being terminated or transformed and sent out of a different vNIC.

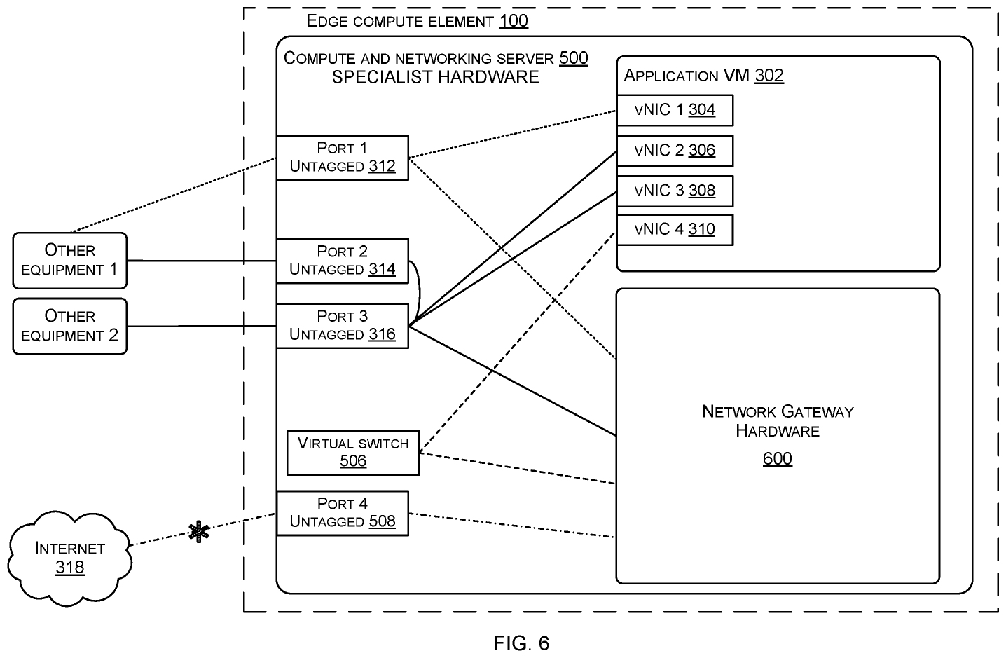

FIG. 6 is a schematic diagram of an edge compute element with specialist hardware 600 which is hardware that performs the function of a network gateway and is expensive. This example is the same as that of FIG. 5 and with the network gateway VM replaced by hardware. This is an extremely expensive option.

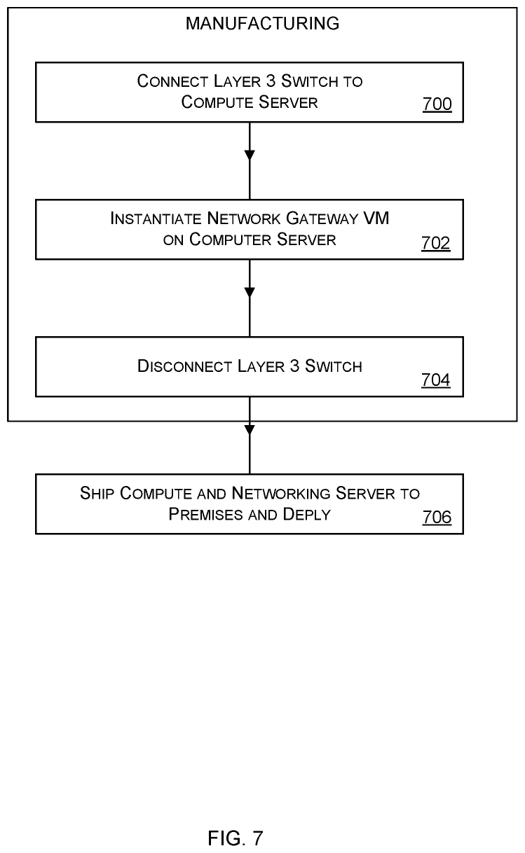

FIG. 7 is a flow diagram of a method during manufacture of a compute and networking server such as that of FIG. 4 or FIG. 5. A generic compute server is obtained and connected 700 to a layer three switch in a manufacturing facility. A network gateway virtual machine is instantiated 702 on the compute server via the layer 3 switch. This is done by logging into the compute server via the layer three switch and triggering install of software at the server to instantiate the network gateway virtual machine. Once the network gateway virtual machine is instantiated and successfully tested, the layer three switch is disconnected 704 from the compute server. The compute server is then shipped 706 to a site or premises and deployed. FIG. 7 explains how to initially deploy the platform in a staging environment that does have external layer 3 switch hardware, and use that environment to deploy the gateway VM onto the compute and networking server. Then move the server to its target environment (at the customer site) where layer 3 switch hardware is not present. During upgrade, ensure that the platform does not rely on external network connectivity for the time when the gateway VM is down.

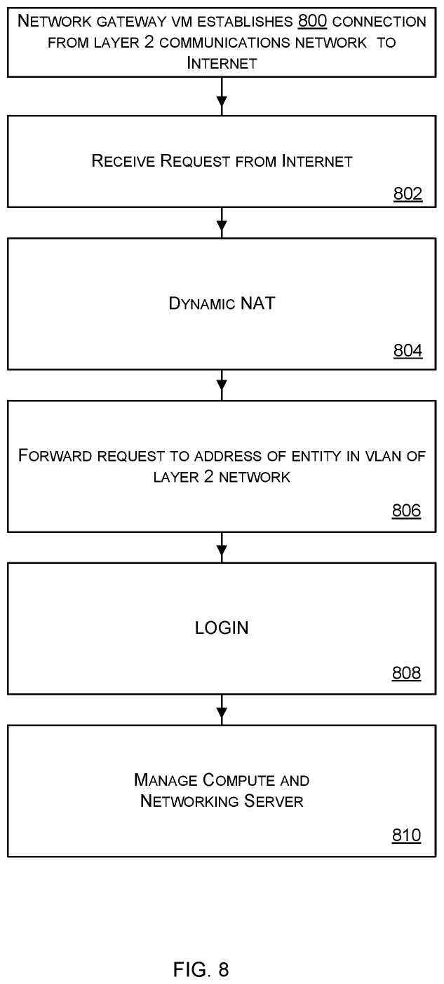

FIG. 8 is a flow diagram of a method of remote management of a compute and networking server such as that of FIG. 4 or FIG. 5. The network gateway VM establishes 800 a connection from the layer 2 communications network to the Internet. A request is received 802 from a remote entity via the connection to the Internet at a vNIC of the network gateway virtual machine. Dynamic network address translation 804 is carried out to convert an internet protocol address of the network gateway VM into an internal layer 3 address, then later the internal layer 3 address is used to find a layer 2 address of an entity in a VLAN of the layer two network. The request is forwarded 806 to the address of the entity in the VLAN of the layer two network, for example the application VM or the compute and networking server. A communication channel is established between the remote entity and the VLAN enabling the remote entity to login 808 and manage 810 the compute and networking server. The management may comprise obtaining diagnostics of the VLANs, carrying out debugging, making configuration changes to the ports of the compute and networking server and for other purposes.

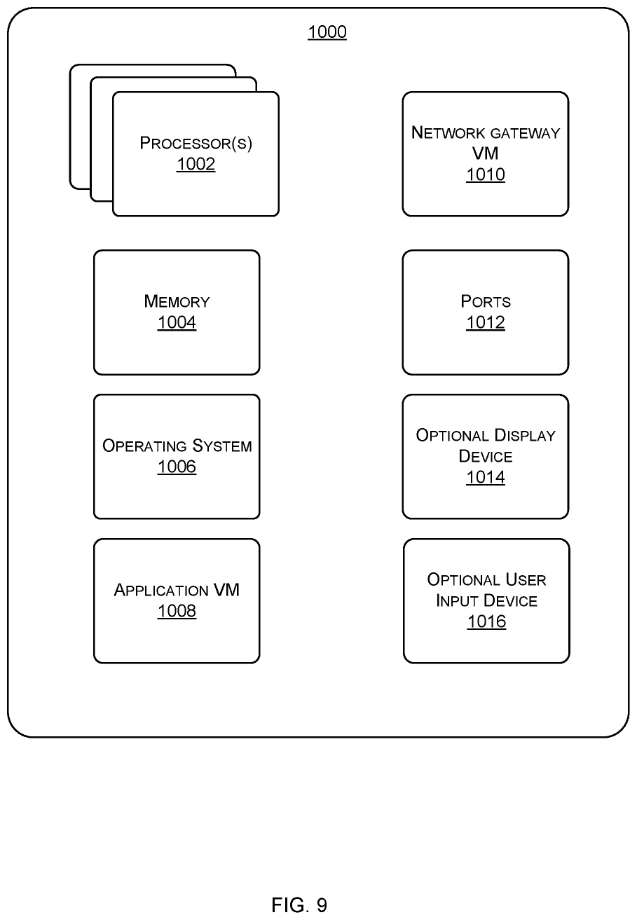

FIG. 9) illustrates an exemplary computing-based device 1000 in which embodiments of a compute and networking server are implemented.

Computing-based device 1000 comprises one or more processors 1002 which are microprocessors, controllers or any other suitable type of processors for processing computer executable instructions to control the operation of the device in order to implement the functionality of the compute and networking server of FIGS. 4 and 5. In some examples, for example where a system on a chip architecture is used, the processors 1002 include one or more fixed function blocks (also referred to as accelerators) which implement a part of the method of FIGS. 7 and 8 in hardware (rather than software or firmware). Platform software comprising an operating system 1006 or any other suitable platform software is provided at the computing-based device to enable application virtual machine 1008 and network gateway virtual machine 1010 to be executed on the device. Ports 1012 enable connection to a layer two communications network via physical connections.

The computer executable instructions are provided using any computer-readable media that is accessible by computing based device 1000. Computer-readable media includes, for example, computer storage media such as memory 1004 and communications media. Computer storage media, such as memory 1004, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1004) is shown within the computing-based device 1000 it will be appreciated that the storage is, in some examples, distributed or located remotely and accessed via a network or other communication link.

The computing-based device 1000 also comprises an optional display device 1014 which may be separate from or integral to the computing-based device 1000. The display information may provide a graphical user interface. An optional user input device 1016 is present. In some examples the user input device 1016 detects voice input, user gestures or other user actions and provides a natural user interface (NUI).

Alternatively, or in addition to the other examples described herein, examples include any combination of the following clauses:

Clause A. An on-premises compute and networking server comprising: a network gateway virtual machine having layer three switching functionality; and a plurality of physical ports physically connected to a layer two communications network at the premises, wherein the layer two communications network only comprises layer two equipment and a modem or other internet access equipment; and wherein the layer two communications network comprises a layer two switch physically connected to the physical ports: or the layer two communications network is deployed absent a layer three switch and the network gateway virtual machine has layer three switching functionality.

Clause B. The compute and networking server of any preceding clause comprising another virtual machine executing an application to provide a service.

Clause C. The compute and networking server of any preceding clause comprising only generic hardware.

Clause D. The compute and networking server of any preceding clause wherein the layer two communications network comprises a plurality of virtual local area networks VLANs.

Clause E. The compute and networking server of any preceding clause wherein one of the ports connects to the internet via a node of the layer two communications network.

Clause F. The compute and networking server of any preceding clause wherein the network gateway virtual machine comprises dynamic network address translation functionality to a public internet protocol IP address.

Clause G. The compute and networking server of any preceding clause comprising another virtual machine executing an application to provide a service and wherein the network gateway virtual machine provides internet connectivity to the application.

Clause H. A method performed by an edge computing device comprising an on-premises compute and networking server, the server having
a network gateway virtual machine having layer three switching functionality; and
a plurality of physical ports physically connected to a layer two communications network at the premises, wherein the layer two communications network only comprises layer two equipment and a modem or other internet access equipment; the method comprising:
receiving a communications packet at one of the ports and routing the packet to or from the internet using the network gateway virtual machine.

Clause I. The method of clause H wherein the communications packet is received from the internet and comprises instructions, and the method comprises managing the compute and networking server by executing the instructions.

Clause J. The method of clause H or clause K comprising, during a manufacturing stage, connecting the compute and networking server to a layer three switch, instantiating the network gateway virtual machine and then disconnecting the layer three switch.

Clause K. A method performed by an edge computing device comprising an on-premises compute and networking server, the method comprising:
receiving, from a layer two communications network at the premises, a communications packet;
wherein the communications packet is received at one of a plurality of physical ports physically connected to the layer two communications network at the premises and bypassing a layer three communications network switch;
routing the packet using layer three functionality of a network gateway virtual machine at the compute and networking server; and comprising sending the packet using a layer two switch: or comprising routing the packet using layer three functionality of the network gateway virtual machine at the compute and networking server and using layer two functionality of the physical ports and an operating system of the compute and networking server.

Clause L. The method of clause K comprising routing the packet to another virtual machine at the compute and networking server, the other virtual machine executing an application to provide a service.

Clause M. The method of clause K or L comprising managing internet connectivity to the application.

Clause N. The method of any of clauses K to M wherein the application provides a fifth generation 5G telecommunications service or a fourth generation 4G telecommunications service.

Clause O. The method of any of clauses K to N wherein the communications packet is received at one of the ports from the internet via a node of the layer two communications network.

Clause P. The method of any of clauses K to O comprising using only generic hardware to implement the compute and networking server.

Clause Q. The method of any of clauses K to P comprising implementing a plurality of virtual local area networks VLANs in the layer two communications network.

Clause R. The method of any of clauses K to Q comprising using one of the ports to connect to the internet via a node of the layer two communications network.

Clause S. The method of any of clauses K to R comprising carrying out dynamic network address translation to a public internet protocol IP address using the network gateway virtual machine.

Clause T. The method of any of clauses K to S performed at an edge of a communications network.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. An on-premises edge compute and networking server comprising:
a network gateway virtual machine having layer three switching functionality; and
a plurality of physical ports physically connected to a layer two communications network at the premises, wherein the layer two communications network only comprises layer two equipment and one of a modem or internet access equipment; and
wherein:
the layer two communications network comprises a layer two switch physically connected to the physical ports: or
the layer two communications network is deployed absent a layer three switch and the network gateway virtual machine has layer three switching functionality.

2. The compute and networking server of claim 1, further comprising another virtual machine executing an application to provide a service.

3. The compute and networking server of claim 1, further comprising only generic hardware.

4. The compute and networking server of claim 1, wherein the layer two communications network comprises a plurality of virtual local area networks VLANs.

5. The compute and networking server of claim 1, wherein one of the ports connects to the internet via a node of the layer two communications network.

6. The compute and networking server of claim 1, wherein the network gateway virtual machine comprises dynamic network address translation functionality to a public internet protocol IP address.

7. The compute and networking server of claim 1, further comprising another virtual machine executing an application to provide a service and wherein the network gateway virtual machine provides internet connectivity to the application.

8. A method performed by an edge computing device comprising an on-premises compute and networking server, the server having:
a network gateway virtual machine having layer three switching functionality; and
a plurality of physical ports physically connected to a layer two communications network at the premises, wherein
the layer two communications network only comprises layer two equipment and one of a modem or internet access equipment;
the method comprising:
receiving a communications packet at one of the ports; and
routing the packet to or from the internet using the network gateway virtual machine.

9. The method of claim 8, wherein the communications packet is received from the internet and comprises instructions, further comprising managing the compute and networking server by executing the instructions.

10. The method of claim 8, further comprising, during a manufacturing stage:
connecting the compute and networking server to a layer three switch;
instantiating the network gateway virtual machine; and
disconnecting the layer three switch.

11. A method performed by an edge computing device comprising an on-premises compute and networking server, the method comprising:
receiving, from a layer two communications network at the premises, a communications packet;
wherein the communications packet is received at one of a plurality of physical ports physically connected to the layer two communications network at the premises and bypassing a layer three communications network switch;
routing the packet using layer three functionality of a network gateway virtual machine at the compute and networking server; and one of:
sending the packet using a layer two switch; or
routing the packet using layer three functionality of the network gateway virtual machine at the compute and networking server and using layer two functionality of the physical ports and an operating system of the compute and networking server.

12. The method of claim 11, further comprising routing the packet to another virtual machine at the compute and networking server, the other virtual machine executing an application configured to provide a service.

13. The method of claim 12, further comprising managing internet connectivity to the application.

14. The method of claim 12, wherein the application provides a fifth generation 5G telecommunications service or a fourth generation 4G telecommunications service.

15. The method of claim 11, wherein the communications packet is received at one of the ports from the internet via a node of the layer two communications network.

16. The method of claim 11, wherein the compute and networking server comprises only generic hardware.

17. The method of claim 11, further comprising implementing a plurality of virtual local area networks VLANs in the layer two communications network.

18. The method of claim 11, further comprising using one of the ports to connect to the internet via a node of the layer two communications network.

19. The method of claim 11, further comprising carrying out dynamic network address translation to a public internet protocol IP address using the network gateway virtual machine.

20. The method of claim 11, wherein the method is performed at an edge of a communications network.
